(19) United States
(12) Patent Application Publication
(10) Pub. No.: US 2025/0238557 A1
(43) Pub. Date: Jul. 24, 2025

(54) PREVENTING KEYSNIFFER ATTACKS

(71) Applicant: Kyndryl, Inc., New York, NY (US)

(72) Inventors: Cesar Augusto Rodriguez Bravo, Alajuela (CR); Kim A. Eckert, Austin, TX (US)

(21) Appl. No.: 18/417,386

(22) Filed: Jan. 19, 2024

(51) Int. Cl. G06F 21/75

(52) U.S. Cl. CPC G06F 21/75

(57) ABSTRACT

Embodiments receive confidential data on a first device; modify the confidential data on the first device by using a randomization pattern; and send the modified confidential data to a second device by wireless communication.

### BACKGROUND

Aspects of the present invention relate generally to preventing keysniffer attacks and, more particularly, to systems and methods of preventing keysniffer attacks by utilizing a randomization pattern.

### SUMMARY

In a first aspect of the invention, there is a computer-implemented method including: receiving, by a computing device, confidential data on a first device; modifying, by the computing device, the confidential data on the first device by using a randomization pattern; and sending, by the computing device, the modified confidential data to a second device by wireless communication.

In another aspect of the invention, there is a computer program product including one or more computer readable storage media having program instructions collectively stored on the one or more computer readable storage media. The program instructions are executable to: receive confidential data on a first device; modify the confidential data on the first device by using a randomization pattern; send the modified confidential data to a second device by wireless communication; remove a modification of the modified confidential data; and output the confidential data for verification.

In another aspect of the invention, there is system including a processor, a computer readable memory, one or more computer readable storage media, and program instructions collectively stored on the one or more computer readable storage media. The program instructions are executable to: pair a first device and a second device via wireless communication; receive confidential data on the first device; modify the confidential data on the first device by using a randomization pattern; send the modified confidential data to the second device by the wireless communication; remove a modification of the modified confidential data; and send the confidential data to an output device connected to the second device, the randomization pattern including an extension pattern.

In another aspect of the invention, there is a computer-implemented method including: paring, by a computing device, a first device to a second device via wireless communication; receiving, by the computing device, confidential data on the first device; modifying, by the computing device, the confidential data on the first device by using a randomization pattern; sending, by the computing device, the modified confidential data to a second device by the wireless communication; removing, by the computing device, a modification of the modified confidential data; and sending, by the computing device, the confidential data to an output device connected to the second device, the randomization pattern including a frequency pattern.

In another aspect of the invention, there is a computer program product including one or more computer readable storage media having program instructions collectively stored on the one or more computer readable storage media. The program instructions are executable to: pair a first device to a second device via wireless communication; receive confidential data on the first device; modify the confidential data on the first device by using a randomization pattern; send the modified confidential data to the second device by the wireless communication; remove a modification of the modified confidential data; and send the confidential data to an output device connected to the second device, the randomization pattern including a charmap pattern.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an obfuscation system in accordance with aspects of the present invention.

FIG. 5 shows a flowchart of an exemplary method in accordance with aspects of the present invention.

FIG. 6 shows highly representative examples of an extension pattern in accordance with aspects of the present invention.

FIG. 7 shows highly representative examples of a frequency pattern in accordance with aspects of the present invention.

FIG. 8 shows highly representative examples of a charmap pattern in accordance with aspects of the present invention.

### DETAILED DESCRIPTION

Aspects of the present invention relate generally to preventing keysniffer attacks and, more particularly, to systems and methods of preventing keysniffer attacks by utilizing a randomization pattern. For example, a keysniffer attack steals sensitive information by intercepting a communication between a first device (e.g., a wireless keyboard) and a second device (e.g., a universal serial bus (USB) dongle for the wireless keyboard), even when encrypted. Aspects of the present invention prevent the exfiltration of data through wireless attacks by injecting random characters into the communication to obfuscate the real data being transmitted. For example, the systems and methods comprise an algorithm that is capable of injecting or removing random keystrokes (e.g., an extension pattern, a frequency pattern, and/or a charmap pattern) to obfuscate real keystrokes, e.g., passwords, etc., during a transmission between a first device and a second device.

In embodiments, the algorithm is loaded on a firmware of the first device and the second device. In specific embodiments, the first device and the second device agree to a first randomization pattern during a handshake protocol, which enhances security between the first device and the second device. Thus, even if the second device is lost, another second device and the first device can agree on a second randomization pattern through a handshake protocol which is different from the first randomization pattern. Accordingly, as different randomization patterns are agreed to by different combinations of devices, security is enhanced as each randomization pattern is unique to a specific combination of devices.

In embodiments, the systems and methods prevent keysniffer attacks between any two devices which communicate to each other through, for example, USB communication. In specific embodiments, the first device is a wireless keyboard and the second device is a USB dongle, although the first device can be a mouse and a second device can be a USB dongle, as well as other examples. In further embodiments, the present invention is also directed to a device which communicates with a laptop, a computer, or a mobile device through an infrared wireless communication protocol, a Bluetooth communication protocol, infrared wireless communication protocol, a Wi-Fi communication protocol or any other wireless communication protocol. In particular, the algorithm can inject or remove random keystrokes to obfuscate real keystrokes during a transmission between the device (e.g., keyboard, mouse, etc.) and one of the laptop, the computer, or the mobile device. In this and other embodiments, the algorithm is loaded on a firmware of the device and within a handshake protocol level of the device.

According to an aspect of the invention, the computer-implemented method includes: setting up a randomization pattern, performing a handshake between a first device and a second device, marking the first device and the second device as paired, and starting a communication of a password between the first device and the second device. The computer-implemented method also includes the randomization pattern being an extension pattern, a frequency pattern, or a charmap pattern as further described herein. In one specific aspect, the computer-implemented method also includes injecting obfuscation keys using the randomization pattern into the password at a first device, transmitting the password with the injected obfuscation keys to a second device, removing the injected obfuscation keys from the password with the injected obfuscation keys, and injecting the password into a user device.

Accordingly, implementations of the present invention provide an improvement in the technical field of keysniffer attacks by injecting or removing random characters to obfuscate real data (e.g., a password, credit card numbers, usernames, security question answers, and other confidential and secret information) being transmitted between a first device and a second device. In this way, the present invention protects all hardware of different brands of devices, including different models and years of the devices. In further embodiments, as the algorithm is implemented in the firmware, the present invention prevents an attacker from gaining access to “a master randomization pattern” because each combination of the devices uses a unique randomization pattern. Further, attackers are not able to gain access to a password by simply intercepting the wireless communication because the first device injects or removes random characters before the password is transmitted to the second device. In contrast, known systems allow hackers to intercept communications between devices because the communication between the devices has very weak or non-existent encryption. Further, known systems do not have antivirus software and do not support firmware updates to enhance the security of communications between devices.

Implementations of the present invention are thus necessarily rooted in computer technology. For example, the step of injecting or removing random characters to obfuscate confidential data is computer-based and cannot be performed in the human mind. In particular, algorithms are loaded onto firmware of devices to obfuscate confidential information before wireless transmission of the confidential information in real-time. Thus, as the system requires a first device and a second device with an algorithm for a randomization pattern, and the ability of first device to wirelessly communicate with the second device, it is not possible for the human mind, or for a person using pen and paper, to obfuscate confidential data to prevent interception of the wireless transmission of the confidential data between the devices.

It should be understood that, to the extent implementations of the invention collect, store, or employ personal information provided by, or obtained from, individuals (for example, a user of the first device and the second device), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

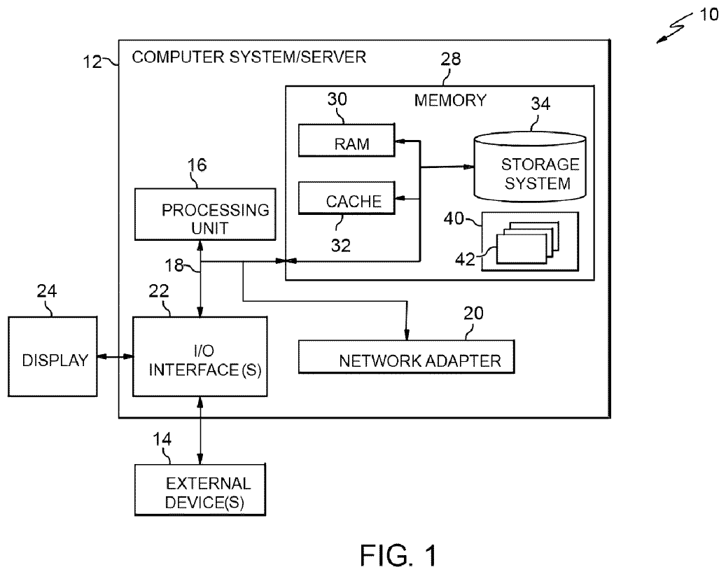

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

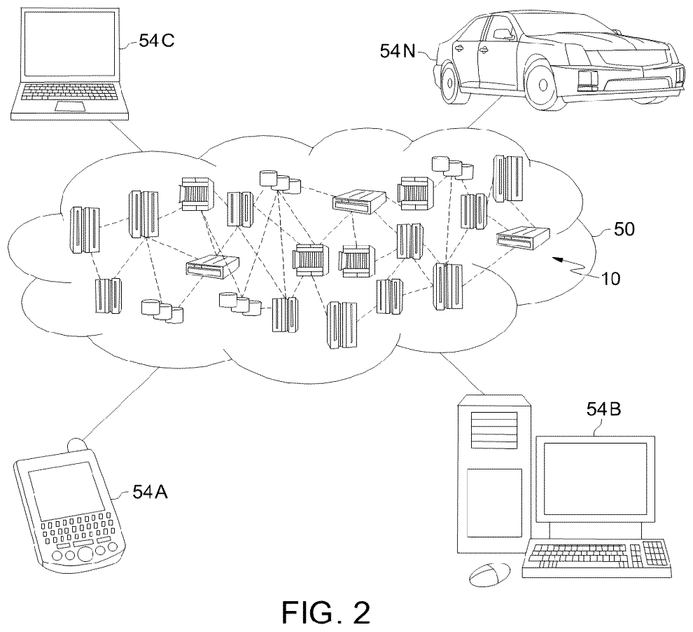

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

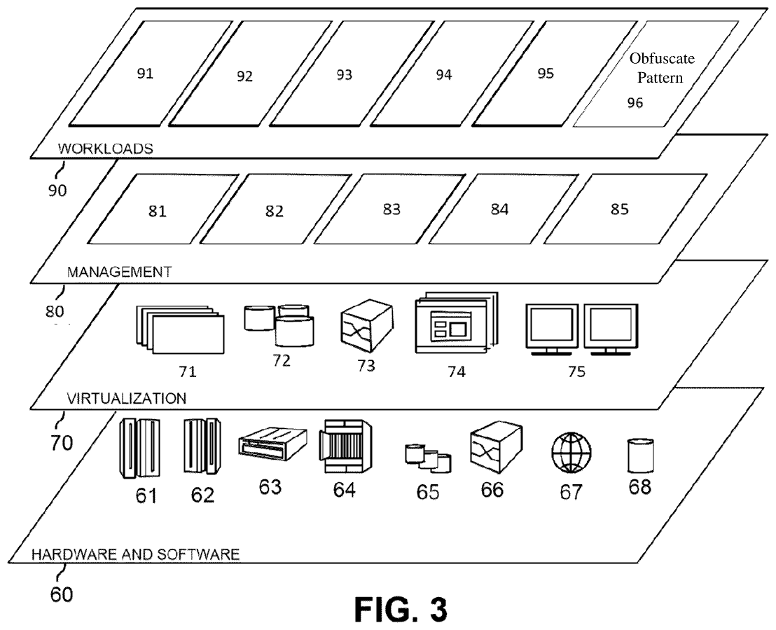

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and obfuscate pattern 96.

Implementations of the invention may include a computer system/server 12 of FIG. 1 in which one or more of the program modules 42 are configured to perform (or cause the computer system/server 12 to perform) one of more functions of the obfuscate pattern 96 of FIG. 3. For example, the one or more of the program modules 42 may be configured to: receive confidential data from a first device; modify the confidential data by a randomization pattern; send the modified confidential data to a second device; remove the modified confidential data; and send the confidential data for verification.

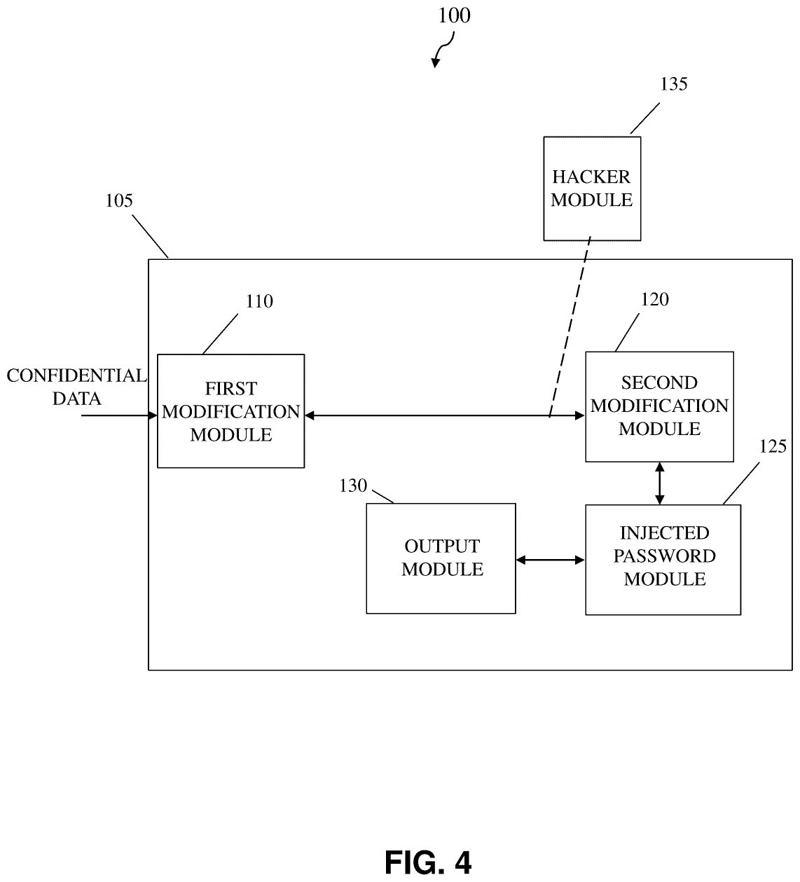

FIG. 4 shows a block diagram of an obfuscation system in accordance with aspects of the invention. In embodiments, the obfuscation system 100 comprises an obfuscation environment 105 which includes a first modification module 110, a second modification module 120, an injected password module 125, and an output module 130, each of which may comprise one or more program modules such as program modules 42 described with respect to FIG. 1 and the obfuscation pattern 96. In embodiments, a hacker module 135 is external to the obfuscation environment 105. Also, in embodiments, a first device includes the first modification module 110 and a second device includes the second modification module 120; although it is also contemplated that the modules 110, 120 may be separate modules.

The obfuscation system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments of FIG. 4, the first modification module 110 pairs with the second modification module 120 through wireless communication between the first modification module 110 and the second modification module 120. In specific embodiments, the first modification module 110 pairs with the second modification module 120 by setting up a randomization pattern on firmware of the first modification module 110 and the second modification module 120, performing a handshake between the first modification module 110 and the second modification module 120 to agree on a common randomization pattern, marking the first modification module 110 and the second modification module 120 as paired, and starting the communication steps. In embodiments, if the first modification module 110 and the second modification module 120 have already been paired, no further pairing steps are necessary and the communications steps can be started.

In FIG. 4, the first modification module 110 receives confidential data from a user. In embodiments, the confidential data can include a password, credit card numbers, usernames, security question answers, etc. In embodiments, the first modification module 110 may include a keyboard which receives the confidential data from a user typing the confidential data on a plurality of keys of the keyboard. In embodiments, the first modification module 110 modifies the confidential data by a randomization pattern and sends the modified confidential data to the second modification module 120. The second modification module 120 may be a dongle, for example. In embodiments, the randomization pattern includes an extension pattern, a frequency pattern, and/or a charmap pattern. Non-limiting examples of the extension pattern, the frequency pattern, and the charmap pattern are provided herein, with the understanding that these patterns may include both adding or removing of a predetermined number of random characters or a progressively increasing number of random characters. The first modification module 110 sends the modified confidential data to the second modification module 120 via wireless or other type of communication.

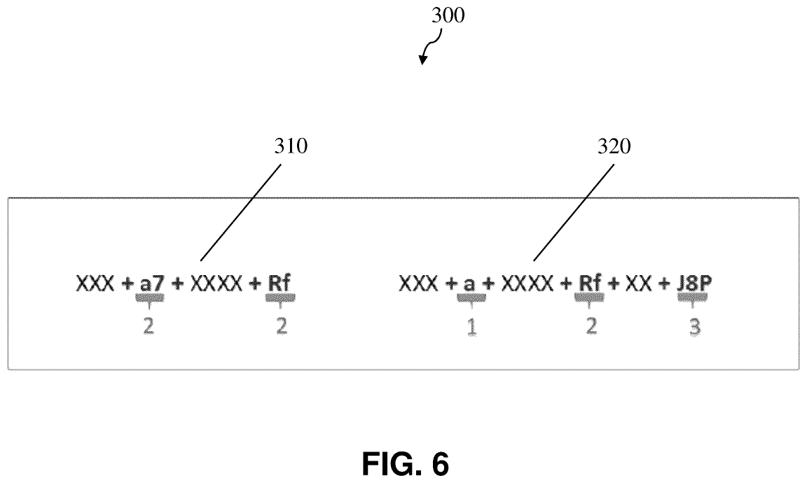

By way of one illustrative example, the extension pattern adds a predetermined number of random characters into the confidential data. For example, the extension pattern can extend the confidential data by adding two characters (as shown in FIG. 6) or by adding a progressively increasing number of characters (also shown in FIG. 6). In other words, the extension pattern can extend the confidential pattern by adding one character or multiple characters (e.g., adding a progressively increasing number of characters).

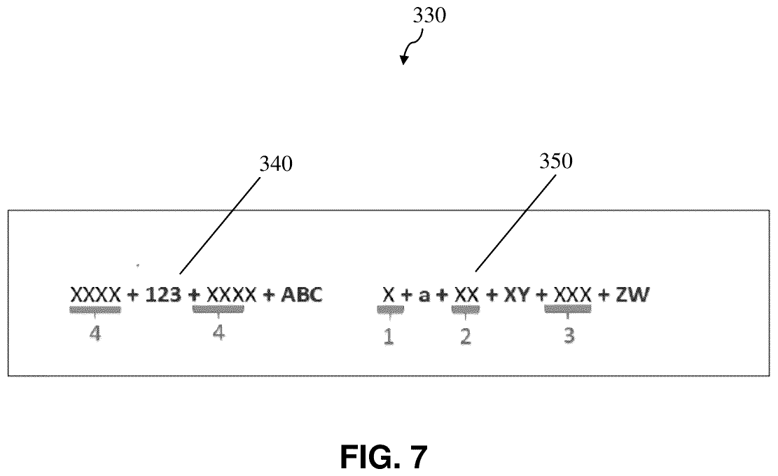

In one illustrative example, the frequency pattern includes random characters at a certain frequency of typed characters which can be injected into confidential data. For example, the frequency pattern comprises random characters which are injected into confidential data after every four characters (as shown in FIG. 7) or random characters which are injected after a progressively increasing number of characters in the confidential data (i.e., after one or more characters, as also shown in FIG. 7).

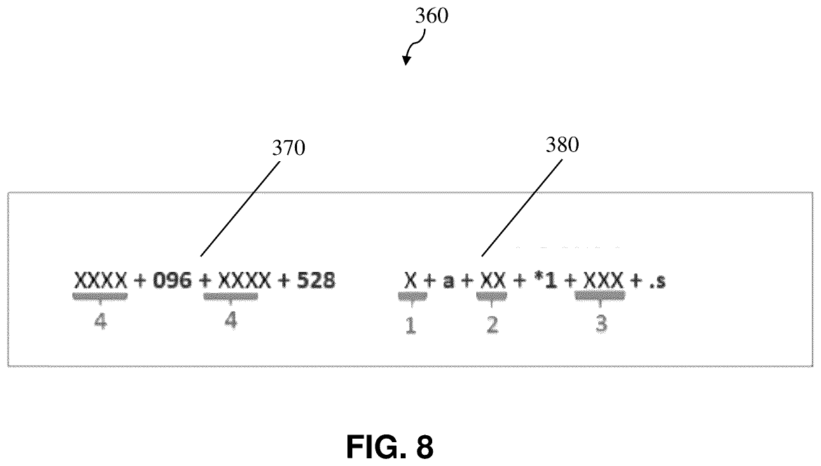

In one illustrative example, the charmap pattern includes random characters after every space, after every return, after a given letter, after a given number, etc., which are injected in the confidential pattern. For example, the charmap pattern includes a predetermined type of characters which are injected in the confidential pattern (i.e., only letters, only numbers, only symbols, all characters, etc.) For example, the charmap pattern comprising only numbers can be injected in the confidential pattern (as shown in FIG. 8). In other examples, the charmap can inject all characters in the confidential pattern (as also shown in FIG. 8).

Still referring to FIG. 4, the hacker module 135 may try to intercept the modified confidential data (as indicated by the dashed line between the first modification module 110 and the second modification module 120). However, when the hacker module 135 tries to enter the modified confidential data into a computing device, the hacker module 135 is unable to verify the modified confidential data. For example, the modified confidential data may be a password which has been intercepted by the hacker. As the modified password is invalid due to the injection or removal of characters, the hacker module 135 intercepting the modified password will be unable to login to the user's account. Accordingly, as the modified password includes either additional injected or removed characters, the intercepted modified password is rendered unusable for accessing an account of a user which requires a password. In this way, the hacker module 135 is prevented from accessing the confidential data (e.g., a password) of the user.

In FIG. 4, the second modification module 120 receives the modified confidential data and uses the common randomization pattern in the firmware to remove the modification such that the confidential data is reverted to its original state (i.e., without any modification). In embodiments, the second modification module 120 receives the modified confidential data at a low level (e.g., a USB stack), identifies the common randomization pattern, and then removes or injects the modification of the modified confidential data. Then, the second modification module 120 sends the confidential data (without any modification) to the injected password module 125.

In FIG. 4, the injected password module 125 sends the confidential data to an output module 130 (e.g., a display of a laptop, a computer, or a mobile device) so that the user can see the confidential data being input to a browser screen of the output module 130 for verifying credentials (e.g., a password input field on a website of the browser screen). Accordingly, embodiments of the present invention allow for the first modification module 110 (e.g., a keyboard) to transmit confidential data (e.g., a password) to the second modification module 120 (e.g., a USB dongle) without the hacker module 135 having access to the confidential data (e.g., the password).

In FIG. 4, a safe mode request can be sent from the user to the obfuscation environment 105. In particular, the safe mode request disables the randomization pattern in each firmware of the first modification module 110 and the second modification module 120 so that the user has direct access to the pre operating system (OS) instructions. In this situation, the user can access the basic input/output system (BIOS) of the laptop, the computer, or the mobile device.

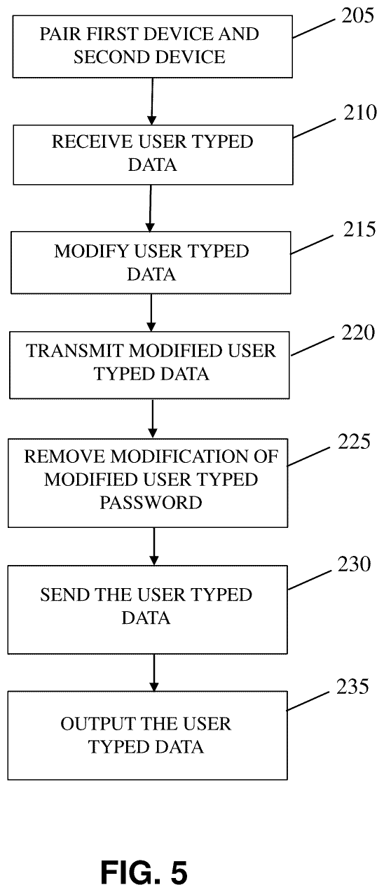

FIG. 5 shows a flowchart of an exemplary method in accordance with aspects of the present invention. Steps of the method may be carried out in the environment of FIG. 4 and are described with reference to elements depicted in FIG. 4. In embodiments, the user typed data can be a password, credit card numbers, usernames, security question answers, etc. In further embodiments, the first device may be a wireless keyboard and the second device may be a USB dongle; although other devices are contemplated herein as described above. In any of the different devices contemplated herein, the randomization pattern is included at a handshake protocol level at which level the hacker is prevented from directly accessing the randomization pattern.

At step 205, the system pairs a first device and a second device which comprise the first modification module 110 and the second modification module 120, respectively. In embodiments, the pairing may be set up using a randomization pattern on each firmware of the first and second devices, followed by performing a handshake between the first and second devices (e.g., first modification module 110 and the second modification module 120) to agree on a common randomization pattern, marking the first and second devices as paired, and then starting the communication steps.

At step 210, the system receives, at the first modification module 110, a user typed data. In embodiments, and as described with respect to FIG. 4, the first modification module 110 may include a keyboard which receives the user typed data from a user typing the data on a plurality of keys of the keyboard.

At step 215, the system modifies, at the first modification module 110, the typed user data. For example, the first modification module 110 modifies the user data by a randomization pattern and sends the modified data to the second modification module 120 of the second device. In embodiments, the randomization pattern may be an extension pattern, a frequency pattern, and/or a charmap pattern.

At step 220, the system transmits the modified user typed data to the second modification module 120. In embodiments, and as described with respect to FIG. 4, although a hacker module 135 may try to intercept the modified data, the hacker module 135 is unable to verify the modified data.

At step 225, the system removes the modification of the data at the second modification module 120. In embodiments, and as described with respect to FIG. 4, the second modification module 120 identifies a common randomization pattern and then removes the modification based on the identified common randomization pattern.

At step 230, the system sends, the user typed data to an output module 130 (e.g., a display of a laptop, a computer, or a mobile device) connected to the second modification module 120. At step 235, the system outputs, at the output module 130, the user typed data to a display so that the user can see the user typed data being input to a browser screen of the output module 130 for verifying credentials of the user typed data.

FIG. 6 shows highly representative examples of an extension pattern in accordance with aspects of the present invention. In embodiments of FIG. 6, the extension pattern examples 300 include a first extension pattern 310 and a second extension pattern 320. In particular, the first extension pattern 310 extends the confidential data by adding a predetermined number of random characters. For example, the extension pattern 310 extends the confidential data by adding two characters after the first three characters and after the next four characters typed by the user.

The second extension pattern 320 extends the confidential data by adding a progressively increasing number of characters. For example, the extension pattern 320 extends the confidential pattern by adding one character, adding two characters, adding three characters, etc. (i.e., adding a progressively increasing number of characters). However, it should be understood that these examples are not limiting to the present invention and that the extension pattern may also remove either a predetermined number of random characters or remove a progressively increasing number of random characters, e.g., two characters, four characters, eight characters, etc.

FIG. 7 shows highly representative examples of a frequency pattern in accordance with aspects of the present invention. In embodiments of FIG. 7, the frequency pattern examples 330 include a first frequency pattern 340 and a second frequency pattern 350. In particular, the first frequency pattern 340 includes a predetermined number of random characters (e.g., three characters) injected into the confidential data after the first four characters and after the next four characters typed by the user. Further, the second frequency pattern 350 includes random characters injected after a progressively increasing number of characters in the confidential pattern (i.e., one random character is injected after one typed character, and two random characters are injected after two typed characters, and three random characters are injected after three typed characters, etc.) However, it should be understood that these examples are not limiting to the present invention and the frequency pattern may be used to remove either a predetermined number of random characters or remove a progressively increasing number of random characters.

FIG. 8 shows highly representative examples of a charmap pattern in accordance with aspects of the present invention. In embodiments of FIG. 8, the charmap pattern examples 360 include a first charmap pattern 370 and a second charmap pattern 380. The first charmap pattern 370 includes random numbers injected into confidential data; whereas the second charmap pattern 380 includes any random character injected into confidential data. In both these examples, the numbers and/or characters can be injected at random locations including after a predetermined number of typed characters (e.g., first charmap pattern 370) or a progressive number of type characters (e.g., second charmap pattern 380).

However, it should be understood that these examples are not limiting to the present invention and that the charmap pattern may be used to add only letters, numbers, characters, symbols or any combination thereof, or, alternatively, be used to remove either a predetermined number of random characters or remove a progressively increasing number of random characters including, for example, removing only letters, numbers, characters, symbols or any combination thereof.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a computing device, confidential data on a first device;
modifying, by the computing device, the confidential data on the first device by using a randomization pattern; and
sending, by the computing device, the modified confidential data to a second device by wireless communication.

2. The method of claim 1, further comprising:
reverting, by the computing device, the modified confidential data into its original state of the confidential data; and
sending, by the computing device, the confidential data to an output device connected to the second device.

3. The method of claim 1, further comprising pairing, by the computing device, the first device to the second device via the wireless communication.

4. The method of claim 3, further comprising performing, by the computing device, a handshake protocol between the first device to the second device.

5. The method of claim 4, further comprising marking, by the computing device, the first device as paired to the second device.

6. The method of claim 1, wherein the randomization pattern comprises an extension pattern by adding a predetermined number of random characters.

7. The method of claim 1, wherein the randomization pattern comprises an extension pattern by adding a progressively increasing number of random characters.

8. The method of claim 1, wherein the randomization pattern comprises a frequency pattern by adding a first predetermined number of random characters after a predetermined frequency.

9. The method of claim 1, wherein the randomization pattern comprises a frequency pattern by adding a progressively increasing number of random characters after a progressively increasing frequency.

10. The method of claim 1, wherein the randomization pattern comprises a charmap pattern by adding a predetermined type of random characters.

11. The method of claim 1, wherein the randomization pattern comprises a charmap pattern by adding a progressively increasing predetermined type of random characters.

12. The method of claim 1, wherein the first device comprises a wireless keyboard which comprises firmware which generates the randomization pattern, and the second device comprises a USB dongle which comprises the firmware which reverts the randomization pattern into an original state of the confidential information.

13. A computer program product comprising one or more computer readable storage media having program instructions collectively stored on the one or more computer readable storage media, the program instructions executable to:
receive confidential data on a first device;
modify the confidential data on the first device by using a randomization pattern;
send the modified confidential data to a second device by wireless communication;
remove a modification of the modified confidential data; and
output the confidential data for verification.

14. The computer program product of claim 13, wherein the randomization pattern comprises an extension pattern.

15. The computer program product of claim 14, wherein the extension pattern extends the confidential data by adding a predetermined number of random characters.

16. The computer program product of claim 14, wherein the extension pattern extends the confidential data by adding a progressively increasing number of random characters.

17. The computer program product of claim 13, wherein the randomization pattern comprises a frequency pattern.

18. The computer program product of claim 17, wherein the frequency pattern modifies the confidential data by adding a first predetermined number of random characters after a predetermined frequency.

19. The computer program product of claim 17, wherein the frequency pattern modifies the confidential data by adding a progressively increasing number of random characters after a progressively increasing frequency.

20. The computer program product of claim 13, wherein the randomization pattern comprises a charmap pattern.

21. The computer program product of claim 20, wherein the charmap pattern modifies the confidential data by adding a predetermined type of random characters.

22. The computer program product of claim 20, wherein the charmap pattern modifies the confidential data by adding a progressively increasing predetermined type of random characters

23. A system comprising:
a processor, a computer readable memory, one or more computer readable storage media, and program instructions collectively stored on the one or more computer readable storage media, the program instructions executable to:
pair a first device and a second device via wireless communication;
receive confidential data on the first device;
modify the confidential data on the first device by using a randomization pattern;
send the modified confidential data to the second device by the wireless communication;
remove a modification of the modified confidential data; and
send the confidential data to an output device connected to the second device,
wherein the randomization pattern comprises an extension pattern.

24. A method comprising:
pairing, by a computing device, a first device to a second device via wireless communication;
receiving, by the computing device, confidential data on the first device;
modifying, by the computing device, the confidential data on the first device by using a randomization pattern;
sending, by the computing device, the modified confidential data to the second device by the wireless communication;
removing, by the computing device, a modification of the modified confidential data; and
sending, by the computing device, the confidential data to an output device connected to the second device,
wherein the randomization pattern comprises a frequency pattern.

25. A computer program product comprising one or more computer readable storage media having program instructions collectively stored on the one or more computer readable storage media, the program instructions executable to:
pair a first device and a second device via wireless communication;
receive confidential data on the first device;
modify the confidential data on the first device by using a randomization pattern;
send the modified confidential data to the second device by the wireless communication;
remove a modification of the modified confidential data; and
send the confidential data to an output device connected to the second device,
wherein the randomization pattern comprises a charmap pattern.
